(19) United States
(12) Patent Application Publication
(10) Pub. No.: US 2023/0064798 A1
(43) Pub. Date: Mar. 2, 2023

(54) Heating Mat With Multiple Discrete Circuits

(71) Applicant: DSM&T Company Inc., Fontana, CA (US)

(72) Inventor: Sergio Corona, Fontana, CA (US)

(21) Appl. No.: 17/459,746

(22) Filed: Aug. 27, 2021

(51) Int. Cl. H05B 3/36; H05B 3/00; B32B 27/08; B32B 7/12; B32B 27/30; B32B 27/36; B32B 37/12; B32B 37/06

(52) U.S. Cl. CPC H05B 3/36; H05B 3/0019; B32B 27/08; B32B 7/12; B32B 27/304; B32B 27/36; B32B 37/12; B32B 37/065; H05B 2203/004; H05B 2203/017; H05B 2203/026; B32B 2250/05; B32B 2250/40; B32B 2305/345; B32B 2307/202; B32B 2457/00

(57) ABSTRACT

A heating pad with a plurality of parallel connected heating circuits that are provided with a temperature control circuit. The parallel connected heating circuits are longitudinally separated from each such that a user may cut or sever the heat mat along predetermined cut points that are indicated on the exterior surface of the heat mat. In this way, the length of the heat mat can be adjusted in the field based on the application by simply cutting the heat mat along a predefined cut point.

### FIELD OF THE INVENTION

The present invention relates to a continuous constructed heat mat with thermostatic control. The continuous construction of the heating elements in the heat mat allows for the mat to be manufactured to virtually any length and allows for field trimming or cutting of the heat mat at predesignated locations while the thermostatic control is used to regulate the temperature of the heat mat to a predetermined set point.

### BACKGROUND OF THE INVENTION

Electric heat mats have been known for some time. For example, U.S. Pat. Nos. 2,425,686 and 2,918,558 are early forms of heat mats. These early systems provided the first type of thermostatic control for resistance electric heating pads.

Later systems are disclosed in U.S. Pat. Nos. 9,370,045, 9,781,772 and 10,064,243. These patents provided significant advantages over known systems providing for thermostatic control for electric heat mats. These newer systems provided an over molded control circuit, a variable-resistance temperature sensor in a vinyl-based heat mat. These heat mats provided a thermostatic control circuit coupled between a source of electrical power and a resistance heating coil. The high resistance metal alloy wire is copper, nickel or stainless steel.

The configuration of these heat mats provides the benefit that a polymer liquid adhesive used in the construction delaminates a polyethylene terephthalate film at temperatures above about 300 degrees F., which functions as a fuse severing the resistance heating wire and halting operation of the heating element in that area.

However, a limitation of this configuration is that the heat mat must be manufactured to size and is not adjustable in the field. For example, if a heat mat is manufactured at a length of 36 inches by 120 inches, this configuration cannot be altered in the field. This is because if the metal alloy wire that functions as the heating element is severed, the break in the circuit results in a system that no longer functions.

Likewise, in applications where, for example, a heat mat is used where heavy loads may move across the heat mat, if the heating element in the heat mat becomes damaged due to a puncture or simply the applied weight, the heat mat stops functioning due to the circuit being open.

Carbon film heating element systems are also known and have been used in various applications, such as for radiant floor heating systems such as U.S. Pat. No. 10,775,050. However, carbon ink or film heating elements as disclosed in this reference cannot be used in damp or wet environments and when subject to such locations, catastrophically fail.

Finally, none of the above references allow for adjustment in the power supplied to a heat mat. For instances where it is desirable to adjust the size of a heat mat in the field, it would be desirable to be able to adjust the power supplied to the field cut heat mat to control the watt/sq inch of the heat mat.

It would be desirable to provide a heat mat that would address the above identified limitations of prior art systems.

### SUMMARY OF THE INVENTION

What is desired then is a system and method of providing a vinyl-based heat mat that is temperature controlled and can be cut to a plurality of different lengths in the field.

It is further desired to provide a vinyl-based heat mat that is temperature controlled and can withstand heavy loads moving across the surface of the heat mat and continue to function even when a portion of the metal alloy used as the heating element becomes damaged.

It is further desired to provide a vinyl-based heat mat allows for a variable or selectable watts/square inch such that when a heat mat is cut in the field, the power supplied to the heat mat can be commensurately adjusted.

In one configuration, a heat mat is provided that comprises five layers including a first upper surface made of poly vinyl chloride with a thickness of approximately 10 mils, a second layer of polyethylene terephthalate (PET), a third layer comprising a metal alloy with a polymer liquid adhesive, a fourth layer of PET, and a fifth bottom layer of poly vinyl chloride with a thickness of approximately 10 mils.

The metal alloy is designed as a Line connection and a Neutral connection at one end of the heat mat. The metal alloy is configured as discrete parallel connected individual heating circuits. For example, the high resistance metal alloy is configured as a first circuit in a zig-zag pattern across a first area of the heat mat that extends from the first end a distance (d) to length (L). One end of the first circuit is electrically connected to the Line and other end of the first circuit is electrically connected to the Neutral.

A second circuit provided in a zig-zag pattern across a second area of the heat mat that extends from length (L2) a distance (d) to length (L3). One end of the second circuit is electrically connected to the Line and other end of the second circuit is electrically connected to the Neutral.

Length (L) is separated a distance (d2) from length (L2) and defines a predefined cutting area where no heating circuit is located. This cutting area may be visibly indicated on the exterior surface of the heat mat as a location where the heat mat could be trimmed or cut.

It is conceived that the heat mat may be made as a continuous roll of material with many circuits (30+) provided. In one exemplary configuration, the heat mat could be provided as a roll of material that is three (3) feet wide by thirty (30) feet in length. In this example, each heating circuit could be provided a little less than three (3) feet wide by approximately one (1) foot in length. In the example described above, the heat mat could then be provided with thirty (30) predefined cutting areas so that a user could cut the heat mat to a length in one (1) foot increments. It is contemplated that the Line and Neutral conductors will run along the outside edges of the heat mat and cutting the heat mat at a predefined cutting area would sever the Line and Neutral conductors but not impact the functioning of any of the remaining heating circuits.

It is contemplated that the heat mat further includes an over molded control circuit and a variable-resistance temperature sensor. For example, a thermostatic control circuit may be coupled between a source of electrical power and heating circuits. The control circuit may include a temperature sensor, a reference voltage generating source, a hysteresis circuit, and a power controller for the heating circuits. The hysteresis circuit may be provided to compare analog signals from the temperature sensor to internally generated reference parameters derived from the reference voltage generating source to provide a control signal to the power controller that selectively varies the power output to the resistance heating element.

In addition, the temperature sensor may comprise a variable-resistance sensor. The reference voltage generating source may include a bridge rectifier to convert AC voltage to DC voltage that is supplied to the power controller. The reference voltage generating source may further include a voltage reference device, such as a diode, to generate a 5V DC reference voltage.

The hysteresis circuit is provided to compare analog signals from the temperature sensor to internally generated reference parameters derived from the reference voltage generating source to provide a control signal to said power controller. The power controller may include a MOSFET to selectively control the power to said heating pad.

It is contemplated that the Watts/sq. ft. will be adjustable. For example, in the illustration of the heat mat comprising 3 feet wide by 30 feet in length, the heat mat could be set to a first wattage (e.g., 90 W providing 1 W/sq. ft. for 90 sq./ft. of heat mat area). If, however, the heat mat is cut to 3 feet wide by 15 feet in length, the 90 W setting would effectively provide 2 W/sq. ft. This may not be desirable. Accordingly, the controller may be set to a lower setting (e.g., 45 W, 30 W, etc.) It is contemplated that any number of power output settings may be provided.

For this application the following terms and definitions shall apply:

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

In one configuration a heat mat is provided that comprises a heat mat having: a first layer of poly vinyl chloride, a second layer of polyethylene terephthalate (PET), a third layer of a plurality of metal alloy heating circuits and a polymer liquid adhesive, a fourth layer of PET, and a fifth layer of poly vinyl chloride. The heat mat is provided such that Line and Neutral conductors extend along a longitudinal length of the heat mat and multiple parallel connected heating circuits are coupled to the Line and Neutral. The heat mat is further provided such that each of the multiple parallel connected heating circuits are longitudinally spaced apart from each such that the heat mat is adapted to be severable along predefined cut points indicated on the exterior of the heat mat where the length of the heat mat may be adjusted to a length corresponding to one of the predefined cut points.

In another configuration method for manufacturing a heat mat is provided that comprises the steps of: providing a layer of polyethylene terephthalate (PET), providing another layer of PET, providing a Line and a Neutral conductor formed as a metal alloy, providing a plurality of metal alloy heating circuits, each heating circuit parallel connected to the Line and Neutral conductors, and placing the Line, the Neutral and the plurality of metal alloy heating circuits between the two layers of PET along with a polymer liquid adhesive to form an inner heating core. The Line and Neutral conductors are provided such that they extend along a longitudinal length of the heating core and each of the multiple parallel connected heating circuits are longitudinally spaced apart from each other. The method further comprises the steps of: providing a layer of poly vinyl chloride, providing another layer of poly vinyl chloride, placing the inner heating core between the two layers of poly vinyl chloride to form a heat mat, degassing the heat mat where the polymer liquid adhesive is an air and solvent-degassed cured acrylic based crosslinked polymer, and heat fusing the two layers of poly vinyl chloride around a periphery of the heat mat. Finally, the method comprises the step of: providing predefined cut points on the exterior surface of the heat mat such that the heat mat is adapted to be severable along the predefined cut points so that the length of the heat mat is adjustable.

Other objects of the invention and its features and advantages will become more apparent from consideration of the following drawings and accompanying detailed description.

### BRIEF DESCRIPTION OF THE DRAWINGS

FIG. 1 is an illustration of simplified schematic of one configuration of the heat mat.

FIG. 2 is an illustration of the simplified schematic according to FIG. 1 where the heat mat has been severed along one of the predefined cut points.

FIG. 3 is a layout of the zig zag pattern for the heating circuits in the heat mat according to FIG. 1.

FIG. 4 is a block diagram of one configuration of the thermostatic control circuit according to FIG. 1.

FIG. 5 is a schematic diagram of the thermostatic control circuit according to FIG. 1.

FIG. 6 is a flowchart illustrating the steps for manufacturing a heat mat according to FIG. 1.

### DETAILED DESCRIPTION OF THE INVENTION

Referring now to the drawings, wherein like reference numerals designate corresponding structure throughout the views.

The invention relates to a heating mat that includes thermostatic control and allows for trimming or cutting of the heat mat to a desired length at predefined cutting locations. It is contemplated that the heat mat may be used for both indoor and outdoor use, including, for example, in areas of vehicle traffic.

In one configuration, a thermostat is encapsulated in a waterproof housing. The thermostat may be provided, for example, as a printed circuit board and connectable to a power supply, temperature sensor and resistance heating coil.

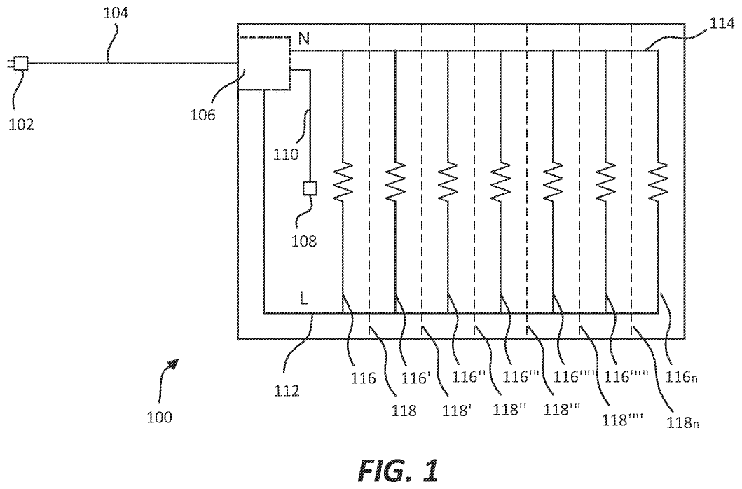

A configuration of the heat mat 100 is illustrated in FIG. 1, including an electrical plug 102, which is designed to be connected to electrical power (e.g., 120V AC). Electrical plug 102 is connected to a cable 104 that in turn is connected to a connection sleeve 106 positioned on heat mat 100. The cable 104 is provide with a plurality of electrical conductors (e.g., line, neutral and ground) that are connectable to an electrical power source via the electrical plug when it is engaged with an electrical socket.

A temperature sensor 108 is coupled to a sensor cable 110 that also couples to the connection sleeve 106. Also depicted in FIG. 1 are Line 112 and Neutral 114 conductors that run along at least a portion of a longitudinal length of heat mat 100. Within connection sleeve 106, Line 112 and Neutral 114 conductors are coupled to the line and neutral conductors in cable 104. Additionally, sensor cable 110 is coupled to data conductors extending from electrical plug 102 to connection sleeve 106.

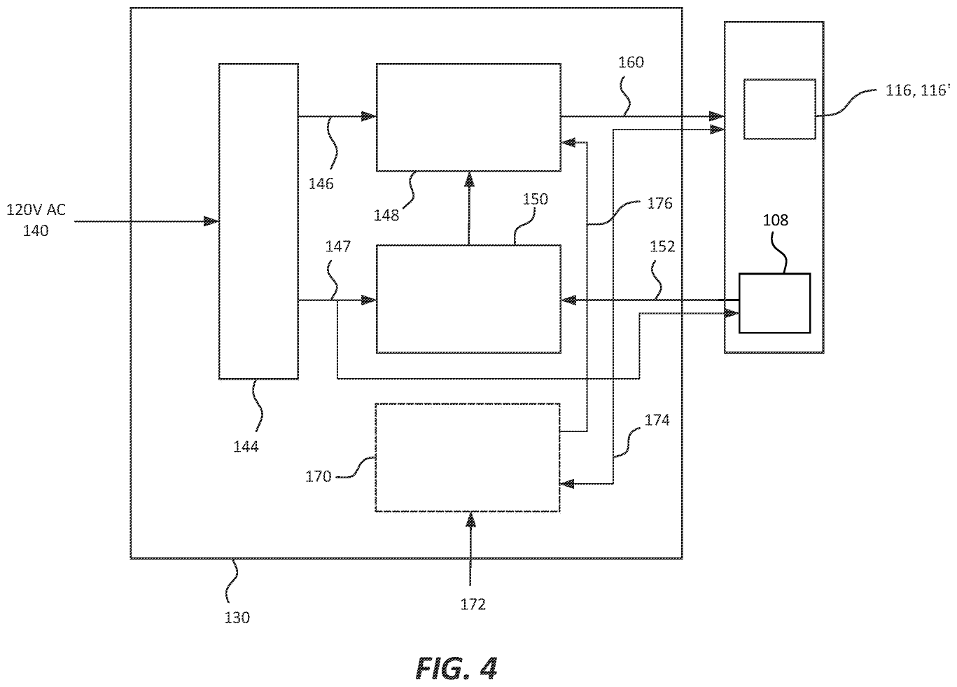

A PCB 130 (see FIG. 4) is positioned within plug housing 102. It is contemplated that plug housing 102 may be overmolded around PCB 130 to seal it in a waterproof fashion. Alternatively, it is contemplated that the PCB 130 and the associated controls may be positioned in connection sleeve 106.

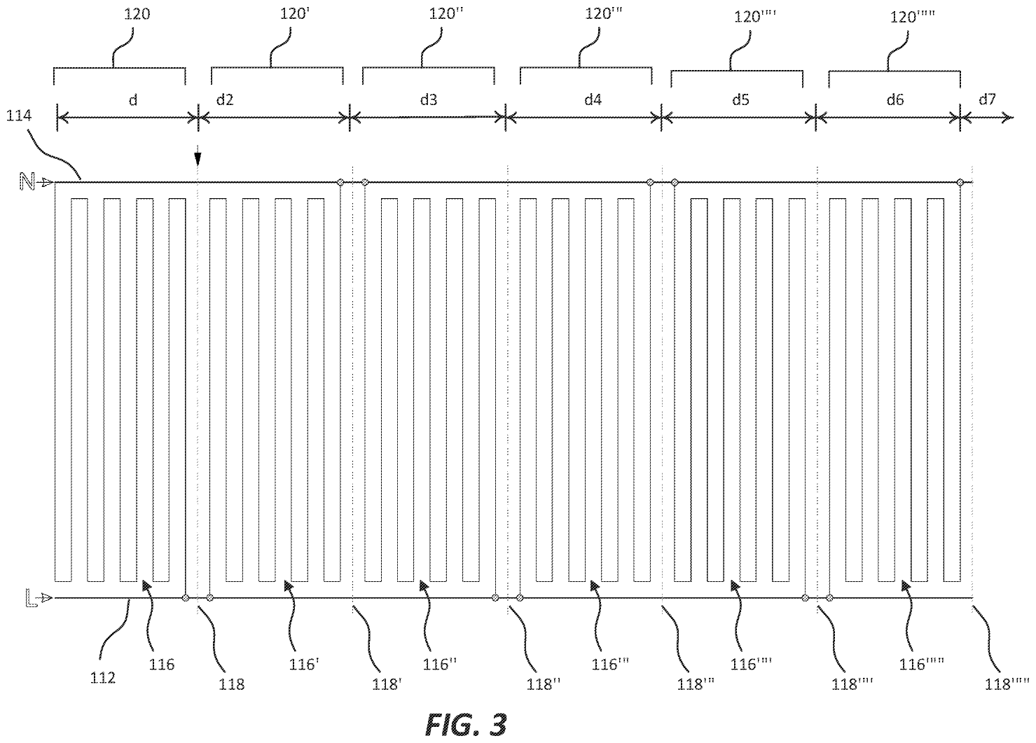

A plurality of parallel connected resistance heating circuits 116, 116′, 116″, 116′″, 116⁻, 116″“′, 116n are connected between the Line 112 and Neutral 114 conductors. Each of the resistance heating circuits 116, 116′, 116”, 116′″, 116″″, 116″″′, 116n are formed of resistance heating element that extends over an area of the heat mat and is illustrated by a resistor symbol. The actual configuration of the resistance heating element for heating circuit 116 is illustrated in FIG. 3 as a zig zag pattern that extends laterally back and forth across an area 120 of the heat mat. Each subsequent heating circuit 116′, 116″, 116″′, 116″″, 116″″′ shown in FIG. 3 each extend laterally back and forth as a zig zag pattern across areas 120′, 120″, 120′″, 120″″, 120″″′ of the heat mat.

Also shown in FIGS. 1-3 are predefined cut points 118, 118′, 118″, 118′″, 118⁻, 118n that indicate areas where the heat mat 100 may be cut or severed. It can be seen in FIG. 3 that none of the heating circuits 116, 116′, 116″, 116′″, 116″″, 116″″ are located along or in any of the predefined cut points 118, 118′, 118″, 118′″, 118″″, 118n.

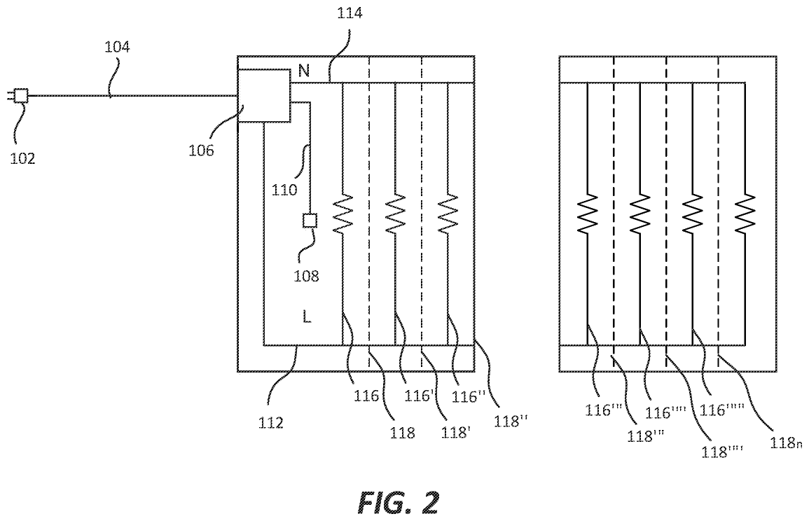

FIG. 2 illustrates the heat mat 100 that has been severed or cut along predefined cut points 118″. In this way, the heat mat 100 can be cut to any preferred length corresponding to the locations of the various predefined cut points. While seven heating circuits are illustrated in FIG. 1, it is contemplated that many additional heating circuits (e.g., 30+) may be parallel connected. For example, in one application the heating mat 100 may be provided as an elongated mat positioned over an area for vehicle traffic where the heat mat prevents the buildup of snow or ice.

The heating circuits 116, 116′, 116″, 116″′, 116″′, 116″″′ and the Line 112 and Neutral 114 conductors are encased within inner protective layers of polymer sheet material such as polyester or more specifically polyethylene terephthalate (PET). The inner protective layers are glued to each other with the heating circuits and the Line 112 and Neutral 114 conductors contained therein. The glue may be a polymer-based adhesive having a viscosity of between 2,000 and 5,000 cps and a density of between 6 and 8 lbs/gal.

The liquid adhesive is polymer, for example, an acrylic polymer dissolved in a solvent. Suitable solvents include toluene, heptane, isopropanol, acetone, ethanol and combinations thereof. The solvent may comprise a solvent blend including 2 or more, 3 or more, 4 or more or all of toluene, heptane, isopropanol, acetone, and ethanol. One adhesive meeting the above requirement is Ashland Aroset 390M. Aroset is a single-package, self-crosslinking acrylic polymer that cures at moderate temperatures upon complete solvent removable. Once cured, the polymer is a pressure sensitive adhesive. The vacuum degassing will apply sufficient pressure allow the adhesive to securely bond the two PET films together.

The resistance heating element and crosslinked acrylic polymer and inner PET sleeve operate like a fuse. Upon overheating, the adhesive expands and delaminates the PET film at high temperatures, for example above about 300-degree F. The as the thin film separates it tears the resistance heating wire. Once the heating wire is severed an open circuit shuts down the operation of the heating pad. More particularly, the MOSFET power controller will shut down if the resistance wire is no longer completing a circuit back to the bridge rectifier.

Temperature control for the heat mat 100 may comprise an electronic circuit that monitors the temperature, establishes a temperature threshold and controls the power output. Temperature sensor 108 is provided that may comprise, for example, a low power thermistor. In one configuration the temperature sensor is disposed at the end of sensor cable 110, so it can be placed in varying distance to the heating circuit(s). The temperature control circuit utilizes a voltage reference and hysteresis circuit to set a temperature threshold for the resistance heating circuits. The control circuit then varies the power provided to the resistance heating circuits to achieve the desired temperature at the sensor.

The temperature control circuit 130 may, for example, be formed on a PCB and is illustrated in FIG. 4. On the input side, an electrical input 140 is coupled to the control circuit 130, and on the output side, the control circuit 130 is coupled to the resistance heating circuits 116, 116′, 116″, 116′″, 116″″, 116″″′. A further input is received from a variable-resistance, low power temperature sensor 108.

More specifically, electrical input 140 provides a 120V AC input to reference voltage generating source 144. Reference voltage generating source 144 provides a DC output 146 (high voltage) to power controller 148, which in turn provided a regulated power output 160 to the resistance heating circuit(s) 116. Reference voltage generating source 144 also provides a DC output 147 (low voltage) to hysteresis circuit 150. More particularly, low voltage DC output 147 is a 5V DC reference voltage that remains stable regardless of load, changes in power supply or temperature. Reference voltage generating source 144 also provides low voltage DC output 147 to temperature sensor 108. The low voltage DC output to temperature sensor 108 may be the same output or may comprise a separate output than provided to hysteresis circuit 150. Temperature sensor 108 is a variable-resistance, low voltage temperature sensor that generates an analog signal 152 that is transmitted to hysteresis circuit 150.

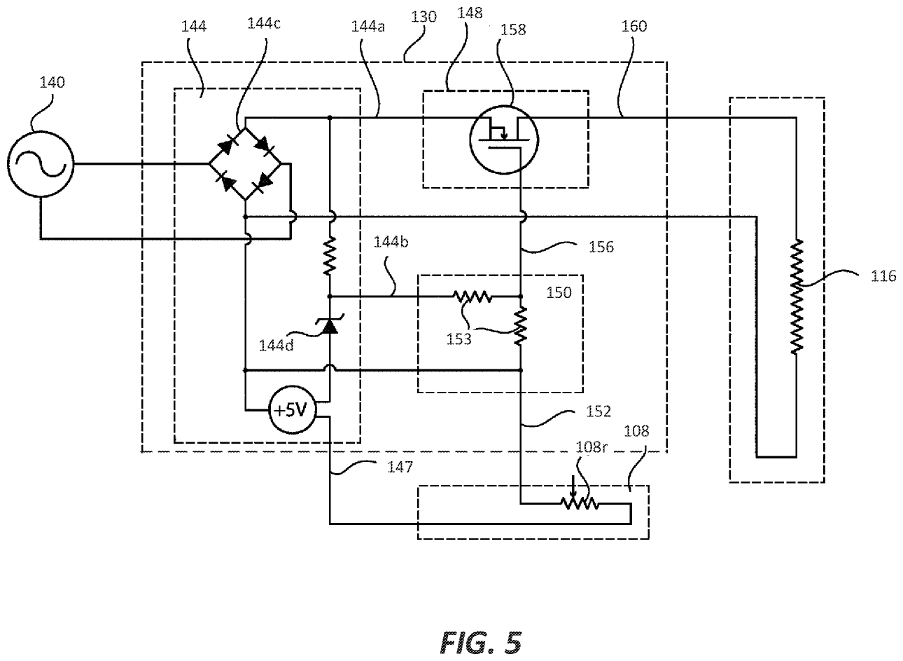

Control circuit 130 is configured as a temperature threshold setting device that may comprise a selectable temperature setpoint. In one configuration shown in FIG. 5 the reference voltage generating source 144 includes a bridge rectifier 144c and a voltage reference diode 144d. The bridge rectifier converts the inputted AC to unregulated high voltage DC output 144a. Voltage reference diode 144d creates a stable voltage reference regardless of load, or changes in power supply or temperature. The voltage reference is 5v, for example, output via low voltage DC output 144b.

Hysteresis circuit 150 includes two thin film resistors 152. Sensor 108 includes a variable resistor 108r that is supplied with low voltage DC output 147. The variable resistor uses electrical impulses to measure the temperature of the heat pad using parameters created with the hysteresis circuit to set the temperature threshold for the resistance heat coil. By adjusting the variable resistor, different temperature thresholds can be set. The hysteresis circuit 150 utilizes the low voltage DC output 147 and sensor output 152 to supply a control signal 156 to power controller 148.

Once the temperature threshold is acquired, a MOSFET 158 within power controller 148 is utilized to selectively control the power that is outputted to the resistance heating circuit(s) 116. The temperature control may comprise a small form factor integrated circuit board that is embedded within a plastic overmold housing that is connected between the electrical input 140 and said heating mat 100. For high heat or commercial applications larger MOSFET power controllers may be utilized. It is further contemplated that the power output of the power controller 148 may be programmable or selectable. For example, it is conceived that if the heat mat 100 is significantly cut in length, a user with an external device via a USB or Bluetooth connection may set the power output to a specified level. This level could be selected based on where the heat mat has been cut. In another example, the control circuit could automatically read the circuit resistance and adjust the power output to maintain a programmed or specified watt/sq ft for the heat mat. For example, a programmable control 170 may be provided that comprises a digital signal processor, a field-programmable gate array, an application-specific integrated circuit, a micro-processor, a micro-controller, or any other form of programmable hardware. A program input 172 may be provided to set a specific watts/sq. ft. The programmable control 170 may then monitor the resistance of the parallel connected circuits with a low voltage sensor connection 174. Based on this reading, the programmable control 170 can then modify the operation of power controller 148 via control connection 176.

The following examples are presented to further illustrate and explain the present invention and should not be taken as limiting in any regard. Unless otherwise mentioned, all parts and percentages are by weight. All physical and mechanical measurements were conducted using industry standard test methods.

The temperature control circuitry may be encased within an overmold flat pack and the resistance heating circuits are sealed within multiple layers including: a) a plastic sleeve layer made from a 10-mil gauge poly vinyl chloride; b) a layer of thermoplastic material comprising PET; c) a layer of polymer liquid adhesive; d) a layer containing high resistance metal alloy wire; e) an additional layer of thermoplastic material comprising PET; and f) an additional plastic sleeve layer made from a 10-mil poly vinyl chloride.

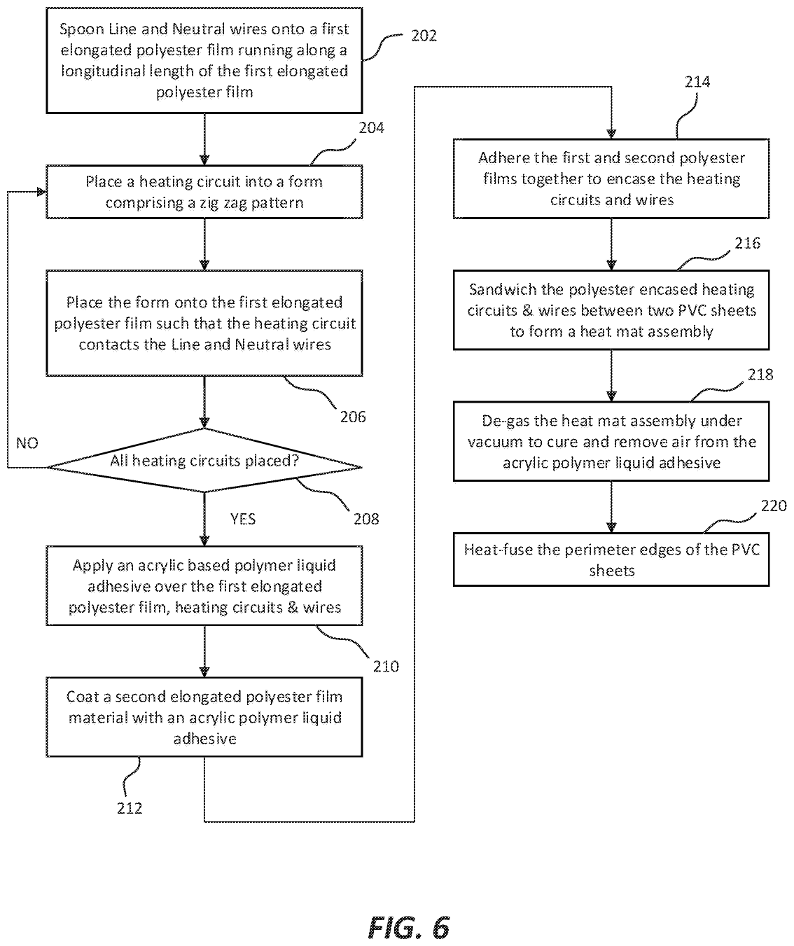

A method of manufacturing a heating pad, according to a further embodiment of the invention, will now be described with respect to FIG. 6. In summary, a polymer adhesive is used to encase resistance heating wire formed as individual parallel connected circuits between two thermoplastic polyester sheets to produce a mat. The mat is then sandwiched between two layers of PVC. In the event a section of the resistance heating wire overheats, the adhesive expands causing the polyester sheets to delaminate thereby severing the wire. The severed wire creates an open circuit that halts operation of the heating pad.

The manufacturing method begins with Spooning Line and Neutral wires onto a first elongated polyester film running along a longitudinal length of the first elongated polyester film 202.

Next, the method includes placing a heating circuit into a form comprising a zig zag pattern 204. The form may be configured as a board with short pegs laid out in a pattern. The resistance wire is wrapped around the pegs taking the shape of the zig zag pattern, to route the wire for even heating across the entire surface of the heating pad. The pegs may be withdrawn down into the board when the wire is ready to be removed from the form.

Next, the form is placed onto the first elongated polyester film such that the heating circuit contacts the Line and Neutral wires 206. The method then proceeds to querying whether all the heating circuits are placed 208. If no, the method proceeds back to step 204 to place the next heating circuit into a form. If all the heating circuits are placed, the method proceeds to applying an acrylic based polymer liquid adhesive over the first elongated polyester film, heating circuits & wires 210.

The liquid adhesive may comprise a single-package, self-crosslinking acrylic-based polymer having a viscosity of between 2,000 and 5,000 cps and a density of between 6 and 8 lbs/gal. Additional adhesive properties include one or more of: a 1.0 mil thick layer of cured adhesive has a coating weight of about 16 lbs/3,000 ft2, a loop tack of about 4.4 lbs/in; a 180.degree. peel adhesion of about 4.3 lbs/in utilizing a 15 minute dwell, a shear adhesion of 24+ hours utilizing 1/2 in x 1/2 in x 500 grams test conditions, and a plasticity of about 2.4 mm. The adhesive is dissolved in a solvent selected from the group consisting of toluene, heptane, isopropanol, acetone, ethanol and combinations thereof.

The next step is to coat a second elongated polyester film material with an acrylic polymer liquid adhesive 212. Once that is done, the method moves to adhere the first and second polyester films together to encase the heating circuits and wires 214.

Now that the heating circuits and wires 214 are held in place by the adhesive and PET film layers, the heating circuits can be removed from the form. For example, the pegs may be withdrawn, allowing the heating circuits to come free of the form and remain adhered to the adhesive and two polyester sheets in the zig zag shape to form an intermediate mat.

Next, the method moves to sandwich the polyester encased heating circuits & wires between two PVC sheets to form a heat mat assembly 216. Since the PVC sheets are larger than the mat they can be fused together. The heating mat is then placed within a clamshell, subject to vacuum and heated to cure the adhesive and fuse the edges of the PVC to each other. This step includes degassing the heat mat assembly under vacuum to cure and remove air from the acrylic polymer liquid adhesive 218.

Degassing includes subjecting the sealed clamshell to −20 to −35 inches Hg vacuum, ideally between −26 to −30 inches Hg vacuum. Heating includes placing the clamshell within an oven for 0.5 to 2.0 hours at 300 to 400 degrees F., ideally about 1.3 hours at 350 degrees F. The final step in the method is to heat-fuse the perimeter edges of the PVC sheets 220 to seal the heat mat.

As discussed previously, in on configuration the temperature control circuit described above and in FIGS. 4 and 5 is sandwiched between two layers of PVC to form a flat pack. The flat pack is coupled to the Line and Neutral conductors, which in turn are connected to the parallel connected heating circuits.

It should be noted that the construction of the mat functions as a fuse. In use, an overheat condition causes the adhesive to expand and delaminate the PET film at high temperatures above about 300-degree F. causing the resistance heating wire to severe causing an open circuit that halts operation of the heating pad.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A heat mat system comprising:
a heat mat having:
a first layer of poly vinyl chloride;
a second layer of polyethylene terephthalate (PET);
a third layer of a plurality of metal alloy heating circuits and a polymer liquid adhesive;
a fourth layer of PET;
a fifth layer of poly vinyl chloride;
wherein Line and Neutral conductors extend along a longitudinal length of the heat mat and multiple parallel connected heating circuits are coupled to the Line and Neutral; and
wherein each of the multiple parallel connected heating circuits are longitudinally spaced apart from each such that the heat mat is adapted to be severable along predefined cut points indicated on the exterior of the heat mat such that the length of the heat mat may be adjusted to a length corresponding to one of the predefined cut points.

2. The heat mat system according to claim 1, wherein the first layer of poly vinyl chloride and the fifth layer of poly vinyl chloride are provided having a thickness of at least 10 mils.

3. The heat mat system according to claim 1, further comprising a control circuit coupled to a source of power and to connection points for the Line and Neutral on the heat mat, wherein the control circuit includes thermostatic control to regulate heat generated by the plurality of heating circuits.

4. The heat mat system according to claim 3, wherein the control circuit provides for adjustable power output to the plurality of heating circuits.

5. The heat mat system according to claim 4, wherein the adjustable power output comprises preselected power settings.

6. The heat mat system according to claim 1, wherein the adhesive, the metal alloy and the PET layers comprise a fuse such that the adhesive delaminates the PET layers at temperatures above about 300° F. causing the metal alloy to break causing an open circuit in the area of the delamination.

7. The heating mat system according to claim 1, wherein said metal alloy wire comprises copper, nickel, stainless steel or combinations thereof.

8. The heating mat system according to claim 1, wherein the adhesive is selected from the group consisting of: a toluene solvent-evaporated cured acrylic based crosslinked polymer adhesive; a heptane solvent-evaporated cured acrylic based crosslinked polymer adhesive; an isopropanol solvent-evaporated cured acrylic based crosslinked polymer adhesive; an acetone solvent-evaporated cured acrylic based crosslinked polymer adhesive; and an ethanol solvent-evaporated cured acrylic based crosslinked polymer adhesive.

9. The heating mat system according to claim 1, wherein the adhesive is an air and solvent-degassed cured acrylic based crosslinked polymer adhesive.

10. The heating mat system according to claim 1, wherein said poly vinyl chloride layers are heat fused together around the periphery of the pad.

11. The heat mat system according to claim 10, wherein the heating mat system is suitable for use in a damp or wet environment.

12. The heating mat system according to claim 1, wherein said metal alloy comprises a resistance heating element.

13. The heating mat system according to claim 1, wherein each of the parallel connected heating circuits are configured in a zig zag type pattern such that the metal alloy connected between the line to the neutral as a heating conductor extends laterally back and forth in an area of the heat mat between the line and neutral conductors.

14. A method for manufacturing a heat mat comprising the steps of:
providing a layer of polyethylene terephthalate (PET);
providing another layer of PET;
providing a Line and a Neutral conductor formed as a metal alloy;
providing a plurality of metal alloy heating circuits, each heating circuit parallel connected to the Line and Neutral conductors;
placing the Line, the Neutral and the plurality of metal alloy heating circuits between the two layers of PET along with a polymer liquid adhesive to form an inner heating core;
wherein Line and Neutral conductors extend along a longitudinal length of the heating core and each of the multiple parallel connected heating circuits are longitudinally spaced apart from each other;
providing a layer of poly vinyl chloride;
providing another layer of poly vinyl chloride;
placing the inner heating core between the two layers of poly vinyl chloride to form a heat mat;
degassing the heat mat where the polymer liquid adhesive is an air and solvent-degassed cured acrylic based crosslinked polymer;
heat fusing the two layers of poly vinyl chloride around a periphery of the heat mat;
providing predefined cut points on the exterior surface of the heat mat such that the heat mat is adapted to be severable along the predefined cut points so that the length of the heat mat is adjustable.

15. The method according to claim 14, wherein the layers of poly vinyl chloride are provided having a thickness of at least 10 mils.

16. The method according to claim 14, further comprising the steps of:
connecting a control circuit to a source of power and to connection points for the Line and Neutral conductors,
regulating the heat generated by the plurality of heating circuits with the control circuit.

17. The method according to claim 16, wherein the control circuit provides for adjustable power to the plurality of heating circuits.

18. The method according to claim 17, wherein the adjustable power is provided based on preselected power settings.

19. The method according to claim 14, wherein each of the parallel connected heating circuits are configured in a zig zag type pattern such that the metal alloy connected between the line to the neutral as a heating conductor extends laterally back and forth in an area of the heat mat between the line and neutral conductors.
